(19) United States
(12) Patent Application Publication
(10) Pub. No.: US 2008/0089380 A1
(43) Pub. Date: Apr. 17, 2008

(54) Laser arrangement and semiconductor laser for optically pumping a laser

(75) Inventors: Harald Konig, Bernhardswald (DE); Johann Luft, Wolfsegg (DE); Martin Muller, Regenstauf (DE); Marc Philippens, Regensburg (DE)

Correspondence Address: Thomas Langer, Suite 1210, 551 Fifth Avenue, New York, NY, 10176, US

(73) Assignee: OSRAM Opto Semiconductors GmbH, Regensburg (DE)

(21) Appl. No.: 11/904,171

(22) Filed: Sep. 26, 2007

(30) Foreign Application Priority Data
Sep. 28, 2006 (DE) 10 2006 046 035.9
Dec. 18, 2006 (DE) 10 2006 059 700.1

(51) Int. Cl. H01S 3/091

(52) U.S. Cl. 372/75

(57) ABSTRACT

A laser arrangement comprises an optically pumped laser (2) and at least one semiconductor laser (1) which emits pump radiation (6) for pumping the optically pumped laser (2). The semiconductor laser (1) contains a plurality of monolithically integrated active zones (3, 4, 5) arranged one above another, at least two of the plurality of active zones (3, 4, 5) emitting pump radiation (6) of different wavelengths. In this way, it is possible to pump different absorption bands of the optically pumped laser (2) using a single semiconductor laser (1).

### RELATED APPLICATIONS

This patent application claims the priority of German Patent Application Nos. 10 2006 046 035.9 filed Sep. 28, 2006 and 10 2006 059 700.1 filed Dec. 18, 2006, the disclosure content of both of which is hereby incorporated by reference.

### FIELD OF THE INVENTION

The invention relates to a laser arrangement comprising an optically pumped laser and at least one semiconductor laser which emits pump radiation for pumping the optically pumped laser, and to a semiconductor laser for optically pumping a laser.

### BACKGROUND OF THE INVENTION

The optical pumping of a laser, in particular of a solid-state laser, can be effected, for example by flash lamps or by a further laser, which is referred to as a pump laser. In particular, a comparatively cost-effective semiconductor laser can be used as the pump laser. In order to increase the pump power and hence the output power of the optically pumped laser, it is possible to use a plurality of semiconductor lasers for optically pumping an optically pumped laser. However, this results in an increase in the outlay for producing the laser arrangement comprising the optically pumped laser and the pump lasers.

The absorptivity of an absorption band of the laser to be pumped is limited by the volume of the light-absorbing medium and can therefore be saturated. Consequently, an increase in the pump power in the region of saturation no longer leads to an increase in the output power of the optically pumped laser. Although the saturation threshold of the optically pumped laser can be increased by enlarging the volume of the laser-active medium, this also disadvantageously increases the structural size and the production costs of the laser.

In order to obtain a high radiation power with an individual semiconductor laser, semiconductor lasers are known which have a monolithically integrated laser diode stack having a plurality of active zones that are arranged one above another on a common substrate. A semiconductor laser of this type is disclosed for example in the document U.S. Pat. No. 6,434,179. Furthermore, the document U.S. Pat. No. 5,212,706 describes an edge emitting semiconductor laser in which a plurality of laser diodes are monolithically deposited one above another and the laser diodes are connected to one another by means of tunnel junctions.

### SUMMARY OF THE INVENTION

One object of the invention is to provide an improved laser arrangement comprising an optically pumped laser and a semiconductor laser for optically pumping the laser, which laser arrangement is distinguished in particular by an improved efficiency of the optical pumping, the structural size and the production outlay of the laser arrangement being comparatively small. Another object is to provide an advantageous semiconductor laser for optically pumping a laser.

This and other objects are attained in accordance with one aspect of the present invention directed to a laser arrangement comprising an optically pumped laser and at least one semiconductor laser which emits pump radiation for pumping the optically pumped laser, the semiconductor laser contains a plurality of monolithically integrated active zones arranged one above another, at least two of the plurality of active zones emitting pump radiation of different wavelengths.

At least one of the active zones arranged one above another within a layer stack thus emits pump radiation of a wavelength λ₁ and at least one further active zone emits pump radiation of a wavelength λ₂, where λ₁≠λ₂. By virtue of the fact that the semiconductor laser that functions as a pump radiation source emits pump radiation of different wavelengths, it is advantageously possible to simultaneously pump a plurality of absorption bands of the optically pumped laser. This is advantageous particularly when the pump radiation of a first wavelength that is emitted by an active zone already suffices to pump an absorption band of the optically pumped laser right into a saturation region. By means of the pump radiation having a second wavelength that is emitted by at least one further active zone, pump radiation can advantageously be radiated into an active medium of the optically pumped laser, which pump radiation is absorbed in a further absorption band. In this way, the effective pump power can be increased without enlarging the volume of the active medium of the optically pumped laser. It is thus advantageous if the different wavelengths of the pump radiation are adapted to different absorption bands of the optically pumped laser.

The laser arrangement according to an embodiment of the invention has the advantage that the optically pumped laser is simultaneously pumped with a plurality of wavelengths without having to integrate a further pump laser into the laser arrangement. The production outlay and the associated costs are advantageously reduced in this way. In particular, this is advantageous in the case of a laser arrangement which is typically pumped only by means of a single semiconductor laser on account of a comparatively low output power of the optically pumped laser.

The optically pumped laser is preferably a solid-state laser. The active medium of the optically pumped laser can have various geometric forms, in particular it can be a bar, a disc or a fiber.

The material of the active medium of the optically pumped laser can be any desired material suitable as active medium of a laser. In particular, the active medium can contain Nd:YAG, Nd:YVO₄, Nd:YAlO₃, Nd:YLF, Yb:YAG or Ti:Sapphire.

The number of the plurality of active zones of the semiconductor laser is preferably between 2 and 10 inclusive. It is possible, for example, for the semiconductor laser to have 3 or more active zones by means of which 3 or more absorption bands of the optically pumped semiconductor laser are pumped. It is also possible for a plurality of the active zones of the semiconductor laser to have an identical emission wavelength in order to obtain a highest possible pump power at this wavelength. In this case, the semiconductor layer contains at least one further active zone which emits at a different wavelength.

The resonator length of the semiconductor laser is preferably between 0.3 mm and 10 mm. In the semiconductor laser, the resonator length is given for example by the distance between the side surfaces of the edge emitting semiconductor laser which form the resonator.

In one preferred embodiment of the invention, the difference between the smallest and the largest of the different wavelengths of the pump radiation is 200 nm or less.

The active zones of the semiconductor laser preferably in each case have a quantum well structure. The quantum well structure can be in particular a single quantum well structure or a multiple quantum well structure. In the context of the application, the designation quantum well structure encompasses any structure in which charge carriers experience a quantization of their energy states as a result of confinement. In particular, the designation quantum well structure does not comprise any indication about the dimensionality of the quantization. It therefore encompasses, inter alia, quantum wells, quantum wires and quantum dots and any combination of these structures.

The different emission wavelengths of the plurality of active zones can be realized in particular by virtue of the fact that the single or multiple quantum well structures of the plurality of active zones differ from one another in terms of their layer thicknesses and/or their material compositions. As an alternative, it is also possible for the dimension of the quantization of the charge carriers to differ from one another in the plurality of active zones. By way of example, one of the plurality of active zones may have quantum dots, while a further active zone has quantum wells.

In a further embodiment of the invention, the laser arrangement contains a plurality of semiconductor lasers for optically pumping the optically pumped laser which in each case have a plurality of monolithically integrated active zones. This is advantageous particularly if the optically pumped laser is a high-power laser, which requires a high pump power that cannot readily be realized using an individual semiconductor laser despite the monolithic integration of a plurality of active zones in the semiconductor laser.

In a laser arrangement in which a plurality of semiconductor lasers are provided for optically pumping the optically pumped laser, the number of semiconductor lasers is preferably between two and two hundred inclusive.

A semiconductor laser according to an embodiment of the invention for optically pumping a laser contains a plurality of monolithically integrated active zones arranged one above another, at least two of the plurality of active zones emitting pump radiation of different wavelengths. The different wavelengths of the pump radiation are advantageously suitable for optically pumping different absorption bands of an active medium to be pumped. In particular, the semiconductor laser according to the invention can be suitable for pumping an active medium containing Nd:YAG, Yb:YAG or Ti:Sapphire. The number of the plurality of active zones of the semiconductor laser according to the invention is preferably between two and ten inclusive.

In one preferred embodiment, a resonator length of the semiconductor laser is between 0.3 mm and 10 mm inclusive.

The difference between the smallest and the largest of the different wavelengths of the pump radiation is preferably 200 nm or less.

The active zones of the semiconductor laser according to an embodiment of the invention preferably in each case have a single or multiple quantum well structure, the quantum well structures of the plurality of active zones advantageously differing from one another in terms of their layer thicknesses and/or their material compositions.

### BRIEF DESCRIPTION OF THE DRAWINGS

FIG. 1 shows a schematic graphical illustration of a cross section through a laser arrangement in accordance with a first exemplary embodiment of the invention,

FIG. 2 shows a schematic graphical illustration of a cross section through a laser arrangement in accordance with a second exemplary embodiment of the invention,

FIG. 3 shows a schematic graphical illustration of a cross section through a laser arrangement in accordance with a third exemplary embodiment of the invention, and

FIG. 4 shows a schematic graphical illustration of a cross section through a semiconductor laser in accordance with one exemplary embodiment of the invention.

### DETAILED DESCRIPTION OF THE DRAWINGS

Identical or identically acting elements are provided with the same reference symbols in the figures. The figures should not be regarded as true to scale, rather individual elements may be illustrated with an exaggerated size for the sake of better illustration.

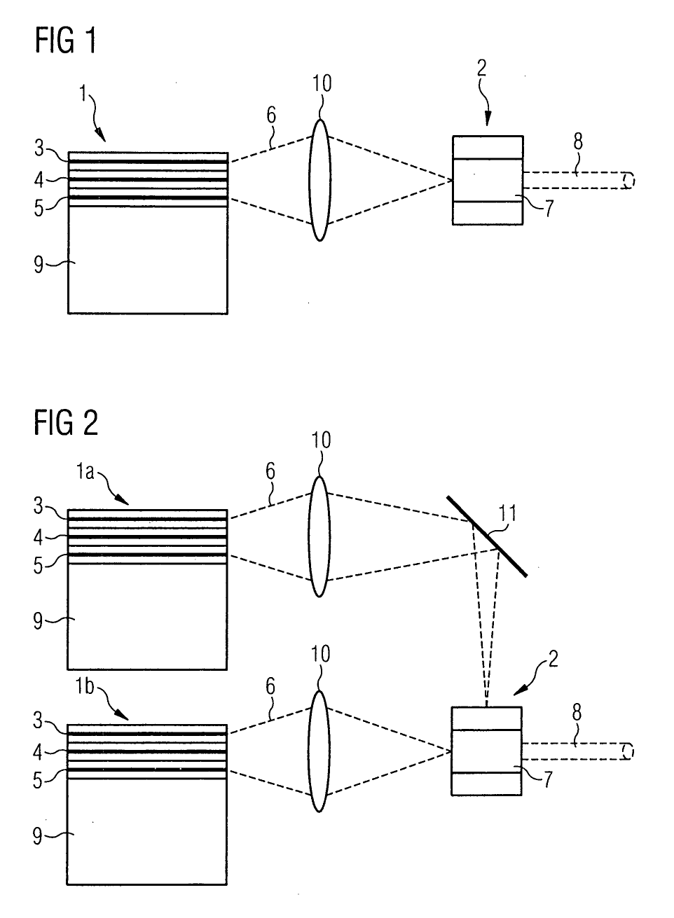

The laser arrangement in accordance with a first exemplary embodiment of the invention as illustrated in FIG. 1 contains an optically pumped laser 2, which emits laser radiation 8. For optically pumping the laser 2, the laser arrangement contains a semiconductor laser 1, which emits pump radiation 6. The dashed lines illustrated in FIG. 1 indicate the envelope of the pump radiation field. The pump radiation 6 is focused by means of a lens 10, for example, into the active medium 7 of the laser 2. Instead of an individual lens 10, it is also possible to provide other optical elements or combinations of optical elements, for example lens combinations, mirrors, diffraction gratings or optical waveguides for diffracting and/or focusing the pump radiation 6 into the active medium 7 of the laser 2.

The semiconductor laser 1 contains a plurality of active zones 3, 4, 5 arranged in monolithically integrated fashion one above another in the semiconductor laser 1. The plurality of active zones 3, 4, 5 can be connected to one another in each case by tunnel junctions (not illustrated) for example in a semiconductor layer sequence applied on a substrate 9. The substrate 9 of the semiconductor laser 1 is a GaAs substrate, for example.

The plurality of active zones 3, 4, 5 emit pump radiation 6 for optically pumping the laser 2, the wavelengths of the emitted pump radiation 6 being different from one another in at least two of the active zones. By way of example, one of the plurality of active zones 3, 4, 5, for example the middle active zone 4, can emit radiation of a first wavelength λ₁, the two remaining active zones, for example the outer active zones 3, 5, emit pump radiation 6 having a second wavelength λ₂, where λ₁≠λ₂.

As an alternative, it is also possible for each of the active zones 3, 4, 5 to emit pump radiation having a wavelength that is different from the wavelengths of the pump radiation emitted by the remaining active zones. In this case, by way of example, the upper active zone 3 emits pump radiation having a wavelength λ₁, the middle active zone 4 emits pump radiation having a wavelength λ₂ and the lower active zone 5 emits pump radiation having a wavelength λ₃.

By virtue of the fact that the semiconductor laser 1 emits pump radiation 6 having different wavelengths, it is advantageously possible for a plurality of absorption bands of the active medium 7 of the optically pumped laser 2 to be simultaneously pumped by means of a single semiconductor laser. For this purpose, the wavelengths emitted by the plurality of active zones are advantageously chosen in such a way that they are suitable for being absorbed in different absorption bands of the active medium 7.

The active medium 7 of the optically pumped laser 2 can have different geometric forms; in particular, the optically pumped laser 2 can be a disc laser, a bar laser or a fiber laser.

The optically pumped laser 2 is preferably a solid-state laser. The latter may contain in particular Nd:YAG, Yb:YAG or Ti:Sapphire as active medium 7. As an alternative, it is also possible to use another laser medium having a plurality of absorption bands suitable for optical pumping.

The optical pumping of a plurality of absorption bands in the active medium 7 of the optically pumped laser 2 is advantageous, in particular, if a first absorption band of the active medium 7 is already pumped right into a saturation region. In this case, an increase in the pump power would not readily lead to an increase in the output power of the laser radiation 8 emitted by the optically pumped laser 2. As a result of pump radiation 6 being radiated into at least one further absorption band of the active medium 7 of the optically pumped laser 2, further electrons can advantageously be raised to an upper laser level of the optically pumped laser 2. The pump power absorbed by the optically pumped laser 2 can advantageously be increased without enlarging the volume of the active medium 7. An optically pumped laser 2 pumped with pump radiation 6 having a plurality of wavelengths can therefore be smaller for the same pump power than a comparable laser that is pumped only with a single wavelength.

A further increase in the pump power can advantageously be obtained by using instead of an individual semiconductor laser 1, a plurality of semiconductor lasers for optically pumping the laser 2.

By way of example, in the case of the laser arrangement illustrated in FIG. 2, an optically pumped laser 2 is optically pumped by a first semiconductor laser 1a and a second semiconductor laser 1b. The embodiment and the advantageous configurations of the semiconductor lasers 1a and 1b correspond to the exemplary embodiment described above; in particular, the semiconductor lasers 1a and 1b thus in each case have a plurality of active zones 3, 4, 5 emitting pump radiation, the wavelengths of the emitted pump radiation differing from one another in at least 2 of the active zones 3, 4, 5.

In the exemplary embodiment, the pump radiation 6 emitted by the semiconductor laser 1a is focused into the active medium 7 of the optically pumped laser 2 by means of a combination comprising a lens 10 and a mirror 11. Furthermore, the pump radiation 6 emitted by the second semiconductor laser 1b is focused into the active medium 7 of the optically pumped laser by means of a further lens 10. In this exemplary embodiment, the pump radiation 6 advantageously reaches the active medium 7 from two directions of incidence that are essentially perpendicular to one another, whereby the homogeneity of the optical pumping of the active medium 7 is advantageously improved.

In the context of the invention, instead of an individual semiconductor laser 1 or two semiconductor lasers 1a, 1b, it is also possible to use a larger number of semiconductor lasers for optical pumping. In the case where a plurality of semiconductor lasers 1a, 1b are used as pump lasers, the laser arrangement preferably contains between two and two hundred semiconductor lasers 1a, 1b inclusive. In this case, any desired optical elements, for example lenses, mirrors, diffraction gratings, optical waveguides or combinations of such elements, can be used for the beam guidance of the pump radiation 6 emitted by the semiconductor lasers 1a, 1b to the active medium 7 of the optically pumped laser 2.

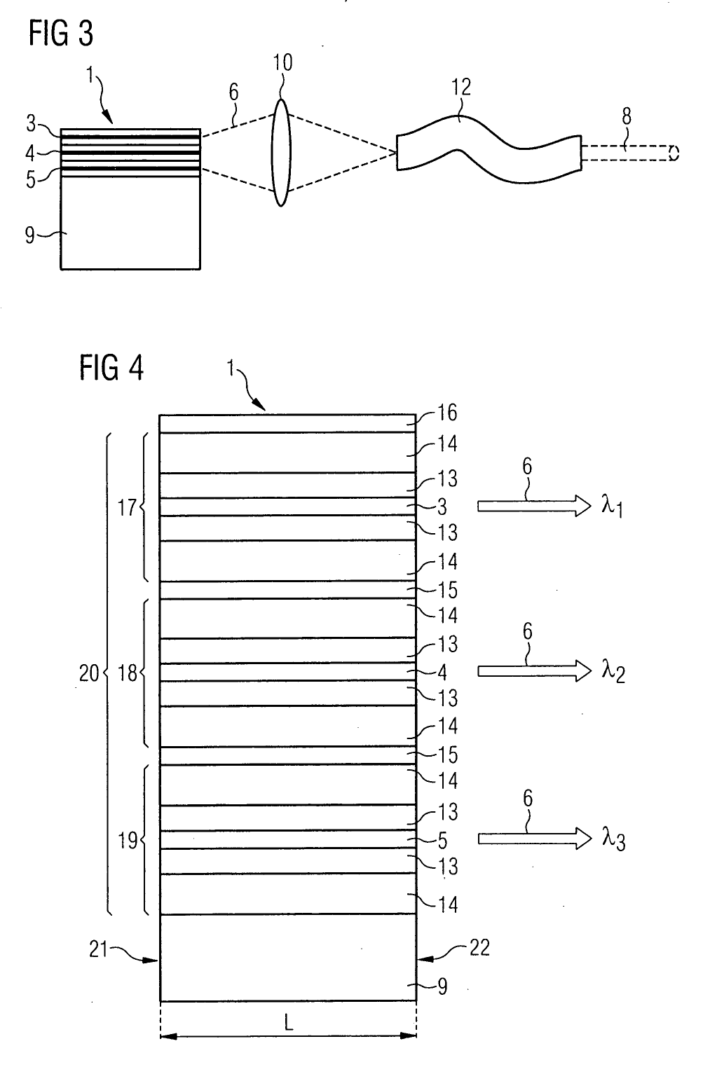

In the exemplary embodiment of a laser arrangement according to the invention as illustrated in FIG. 3, the optically pumped laser 2 is a fiber laser, in which the active medium 7 is formed by a fiber 12. The fiber laser 2 is pumped by a semiconductor laser containing a plurality of active zones 3, 4, 5 according to the invention, at least two of the plurality of active zones 3, 4, 5 emitting pump radiation 6 having different wavelengths. The different wavelengths of the pump radiation 6 are advantageously adapted to different absorption bands of the fiber.

The pump radiation 6 is preferably focused into one end of the fiber 12 by means of a lens 10 or other optical elements. The laser radiation 8 of the laser 2 is emitted for example from the opposite end of the fiber 12.

For the rest, the third exemplary embodiment corresponds to the first exemplary embodiment of the invention as described above.

FIG. 4 illustrates schematically in cross section a semiconductor laser 1 in accordance with one exemplary embodiment of the invention. The advantageous configurations of the semiconductor laser 1 that are explained below on the basis of this exemplary embodiment also apply to the semiconductor lasers illustrated above in exemplary embodiments 1 to 3 of the laser arrangement according to the invention.

The semiconductor laser 1 contains a semiconductor layer sequence 20 applied to a substrate 9 and comprising a plurality of monolithically integrated laser diodes, for example three laser diodes 17, 18, 19. The laser diodes 17, 18, 19 are preferably connected to one another by tunnel junctions 15.

Each of the laser diodes 17, 18, 19 contains an active zone 3, 4, 5, from which radiation 6 is emitted. The radiation 6 emitted by the plurality of active zones 3, 4, 5 is provided for pumping an optically pumped laser.

At least two of the plurality of active zone 3, 4, 5 emit pump radiation 6 whose wavelength differs from one another. By way of example, the topmost active layer 3 arranged in the semiconductor layer sequence 20 emits pump radiation 6 having a wavelength λ₁, a middle active layer 4 arranged in the semiconductor layer sequence 20 emits pump radiation 6 having a wavelength λ₂, and a lower active layer 5 arranged in the semiconductor layer sequence 20 emits pump radiation 6 having a wavelength λ₃. In this case, the wavelengths λ₁, λ₂ and λ₃ advantageously correspond to the absorption bands of an optically pumped laser which is to be pumped by the semiconductor laser 1.

In particular, the semiconductor laser 1 may be suitable for optically pumping a solid-state laser, in which case the solid-state laser may contain for example Nd:YAG, Yb:YAG or Ti:Sapphire as active medium.

In order to obtain the different emission wavelengths λ₁, λ₂ and λ₃, the active zones 3, 4, 5 differ from one another for example in terms of their material and/or their layer thicknesses.

Preferably, the active zones 3, 4, 5 in each case contain a quantum well structure. In the case where the active zones 3, 4, 5 are formed as a quantum well structure, the laser threshold is comparatively low in comparison with a semiconductor laser having a conventional pn-junction as active zone. Furthermore, the temperature dependence of the emission wavelengths is also advantageously low in this case.

The quantum well structures of the plurality of active zones 3, 4, 5 can differ from one another in terms of their material composition and/or their layer thicknesses in order to obtain different emission wavelengths λ₁, λ₂ and λ₃.

As an alternative, it is also possible for the quantum well structures to differ from one another in terms of the dimensionality of the quantization. By way of example, one of the quantum well structures can contain quantum dots, while at least one of the further quantum well structures contains quantum wells or quantum wires. The wavelength difference between the shortest of the emitted wavelengths λ₁, λ₂ and λ₃ and the longest emitted wavelength is for example 200 nm or less.

In the exemplary embodiment illustrated, three active zones 3, 4, 5 are arranged in the semiconductor laser 1. In the context of the invention, however, a different number of active zones is also conceivable, preferably between two and ten active zones inclusive being arranged in the semiconductor laser 1.

The active zones 3, 4, 5 are preferably embedded in waveguide layers 13, the waveguide layers 13 being surrounded by cladding layers 14. Between the waveguide layers 13 and the cladding layers 14 there is advantageously a refractive index difference such that the laser radiation is guided in the waveguide 13. The thicknesses and the material compositions of the waveguide layers 13 and/or of the cladding layers 14 do not have to be identical in all the laser diodes 17, 18, 19, but rather can also deviate from one another.

The laser resonator of the semiconductor laser 1 is formed for example by the side surfaces 21, 22 of the semiconductor layer sequence 20. An at least partial reflection of the laser radiation generated in the active zones 3, 4, 5 at the side surfaces 21, 22 is effected, for example on account of the refractive index jump between the material of the semiconductor layer sequence 20 and the surrounding medium, for example air. As an alternative, the side surfaces 21, 22 of the semiconductor laser 1 can also be provided with a reflection-increasing coating (not illustrated).

In one preferred embodiment of the invention, the length L of the laser resonator is between 0.3 mm and 10 mm inclusive.

Electrical contact can be made with the semiconductor laser 1 for example by using a conductive substrate 9, which constitutes a first electrical contact of the semiconductor layer sequence 20. A second electrical contact of the semiconductor layer sequence 20 is formed by a contact layer 16, for example, which is applied to a surface of the semiconductor layer sequence 20 that is opposite to the substrate 9.

The semiconductor layer sequence 20 of the semiconductor laser 1 is preferably based on a III-V compound semiconductor material, in particular on an arsenide, nitride or phosphide compound semiconductor material.

By way of example, the semiconductor layer sequence 20 may contain InₓAl_{y}Ga_{1-x-y}N, InₓAl_{y}Ga_{1-x-y}P or InₓAl_{y}Ga_{1-x-y}As, in each case were 0≦x≦1, 0≦y≦1 and x+y≦1. In this case, the III-V compound semiconductor material need not necessarily have a mathematically exact composition according to one of the above formulae. Rather, it can have one or more dopants and also additional constituents which do not substantially change the physical properties of the material. For the sake of simplicity, however, the above formulae comprise only the essential constituents of the crystal lattice, even though these can be replaced in part by small quantities of further substances.

The material selection for the semiconductor layer sequence 20 is effected on the basis of the desired emission wavelengths of the semiconductor laser 1. The substrate 9 is selected on the basis of the semiconductor layer sequence 20 that is preferably to be grown epitaxially, and can be in particular a GaAs—, GaN—, SiC— or silicon substrate.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

We claim:

1. A laser arrangement comprising an optically pumped laser and at least one semiconductor laser which emits pump radiation for pumping the optically pumped laser,
wherein
the semiconductor laser contains a plurality of monolithically integrated active zones arranged one above another, at least two of the plurality of active zones emitting pump radiation of different wavelengths.

2. The laser arrangement as claimed in claim 1,
wherein
the different wavelengths of the pump radiation are suitable for optically pumping different absorption bands of an active medium of the optically pumped laser.

3. The laser arrangement as claimed in claim 1,
wherein
the optically pumped laser is a solid-state laser.

4. The laser arrangement as claimed in claim 1,
wherein
an active medium of the optically pumped laser contains Nd:YAG, Nd:YVO₄, Nd:YAlO₃, Nd:YLF, Yb:YAG or Ti:Sapphire.

5. The laser arrangement as claimed in claim 1,
wherein
a number of the plurality of active zones of the semiconductor laser is between 2 and 10 inclusive.

6. The laser arrangement as claimed in claim 1,
wherein
a resonator length L of the semiconductor laser is between 0.3 mm and 10 mm inclusive.

7. The laser arrangement as claimed in claim 1,
wherein
the difference between the smallest and the largest of the different wavelengths is 200 nm or less.

8. The laser arrangement as claimed in claim 1,
wherein
the active zones in each case have a quantum well structure.

9. The laser arrangement as claimed in claim 8,
wherein
the quantum well structures of the plurality of active zones differ from one another in terms of their layer thicknesses and/or their material compositions.

10. The laser arrangement as claimed in claim 1,
wherein
the laser arrangement contains, for optically pumping the laser a plurality of semiconductor lasers each having a plurality of monolithically integrated active zones arranged one above another.

11. The laser arrangement as claimed in claim 10,
wherein
the number of semiconductor lasers is between 2 and 200 inclusive.

12. A semiconductor laser for optically pumping a laser,
wherein
the semiconductor laser has a plurality of monolithically integrated active zones arranged one above another, at least two of the plurality of active zones emitting pump radiation of different wavelengths.

13. The semiconductor laser as claimed in claim 12,
wherein
the different wavelengths of the pump radiation are suitable for optically pumping different absorption bands of an active medium to be pumped.

14. The semiconductor laser as claimed in claim 13,
wherein
the active medium contains Nd:YAG, Nd:YVO₄, Nd:YAlO₃, Nd:YLF, Yb:YAG or Ti:Sapphire.

15. The semiconductor laser as claimed in claim 12,
wherein
a number of the plurality of active zones is between 2 and 10 inclusive.

16. The semiconductor laser as claimed in claim 12,
wherein
a resonator length L of the semiconductor laser is between 0.3 mm and 10 mm inclusive.

17. The semiconductor laser as claimed in claim 12,
wherein
the difference between the smallest and the largest of the different wavelengths is 200 nm or less.

18. The semiconductor laser as claimed in claim 12,
wherein
the active zones in each case have a quantum well structure.

19. The semiconductor laser as claimed in claim 18,
wherein
the quantum well structures of the plurality of active zones differ from one another in terms of their layer thicknesses and/or their material compositions.
